(19) United States
(12) Patent Application Publication
(10) Pub. No.: US 2010/0273066 A1
(43) Pub. Date: Oct. 28, 2010

(54) Rechargeable Lithium Air Battery Cell Having Electrolyte with Alkylene Additive

(75) Inventors: John Scott Flanagan, Chamblee, GA (US); Prabhakar A. Tamirisa, Brooklyn Park, MN (US); Ji-Guang Zhang, Richland, WA (US)

Correspondence Address: Excellatron-JRD: Legal Department, 263 Decatur Street, Atlanta, GA, 30312, US

(73) Assignee: EXCELLATRON SOLID STATE LLC, Atlanta, GA (US)

(21) Appl. No.: 12/752,754

(22) Filed: Apr. 1, 2010

Related U.S. Application Data
(63) Continuation-in-part of application No. 11/843,814, filed on Aug. 23, 2007.

(51) Int. Cl. H01M 6/16

(52) U.S. Cl. 429/338; 429/324

(57) ABSTRACT

A rechargeable lithium-air battery (10) comprises a non-aqueous, organic-solvent-based electrolyte (16) including a lithium salt and an additive containing an alkylene group, disposed between a spaced-apart pair of a lithium anode (12) and an air cathode (14). The alkylene additive may be alkylene carbonate, alkylene siloxane, or a combination of alkylene carbonate and alkylene siloxane. The alkylene carbonate may be vinylene carbonate, butylene carbonate, or a combination of vinylene carbonate and butylene carbonate. The alkylene siloxane may be a polymerizable silane. The polymerizable silane is triacetoxyvinylsilane.

### RELATED APPLICATIONS

This application claims priority to U.S. patent application Ser. No. 11/843,814 filed Aug. 23, 2007, the entirety of which is incorporated herein by reference.

### TECHNICAL FIELD

This invention relates to rechargeable battery cells, and more particularly, the invention relates to additives for electrolytes of rechargeable, lithium-air battery cells.

### BACKGROUND OF THE INVENTION

A battery cell is a particularly useful article that provides stored electrical energy that can be used to energize a multitude of devices that require an electrical power source. A battery cell, which is often referred to, somewhat inaccurately, in an abbreviated form as a “battery,” is an electrochemical apparatus typically formed of at least one electrolyte (also referred to as an “electrolytic conductor”) disposed between a pair of spaced-apart electrodes. The electrodes and electrolyte are the reactants for a chemical reaction that causes an electric current to flow between the electrodes when the electrode ends that are not in contact with the electrolyte are connected to one another through an object or device (generally referred to as the “load”) to be powered. The flow of electrons through the free ends of the electrodes is accompanied and caused by the creation and flow of ions in and through the electrolyte.

In a non-rechargeable battery cell, the chemical reaction that produces the flow of electric current also causes one or more of the reactants to be consumed or degraded over time as the cell discharges, thereby depleting the cell. On the other hand, in a rechargeable battery cell, after the cell has partially or fully discharged its electrical potential, the chemical reaction may be reversed by applying an electric current to the cell that causes electrons to flow in an opposite direction between the electrodes. Thus it can be appreciated that rechargeable battery cells are extremely useful as a source of electrical power that can be replenished.

A problem in utilizing rechargeable batteries is that it is often difficult to return the reactants to their original, pre-use state, that is, the pristine or ideal (or as close as possible) condition that the reactants are in before the cell is used. This problem relates to specific problems associated with returning each individual reactant to its original state.

Lithium-air batteries are useful batteries because they provide high energy density from easily-obtainable and inexpensive electrode reactant materials, namely, lithium and air. In a lithium-air battery, lithium serves as the anode while the cathode is formed of a light-weight, inexpensive substrate that is capable of supporting a catalyst for facilitating oxygen's role as a reactant.

A problem with rechargeable, lithium-air batteries is that they are particularly difficult to recharge multiple times due to the characteristics of lithium and a difficulty in recharging an air cathode. Thus these batteries have a very limited useful life.

Therefore, it can be appreciated that it would be useful to have a rechargeable lithium-air battery cell that can be discharged and recharged effectively many times.

A concern in recharging a rechargeable battery is how much electrical energy will be required to restore the battery to its pre-discharged state and potential. The level of electrical energy that must be applied to restore a rechargeable battery to its pre-discharged state is typically greater than the electrical energy initially provided by the battery. However, it is desirable that the electrical energy required to recharge a rechargeable battery be minimized so as to reduce the cost of operation and to prevent damage to the battery. Thus it can be appreciated that it would be useful to have a rechargeable lithium-air battery for which the voltage level required to recharge the battery is minimized, thus minimizing the amount energy required to recharge the cell.

### SUMMARY OF THE INVENTION

According to the present invention, a rechargeable lithium-air battery comprises a non-aqueous, organic-solvent-based electrolyte including a lithium salt and an additive containing an alkylene group, disposed between a spaced-apart pair of an anode and a cathode. In particular, the cathode is an air cathode.

In one embodiment of the invention, the alkylene additive is selected from the group consisting of alkylene carbonate, alkylene siloxane, and a combination of alkylene carbonate and alkylene siloxane.

In an aspect of this embodiment, alkylene carbonate is selected from the group consisting of vinylene carbonate, butylene carbonate, and a combination of vinylene carbonate and butylene carbonate.

In another aspect of this embodiment, alkylene siloxane is a polymerizable silane. And in a further aspect, the polymerizable silane is triacetoxyvinylsilane.

In another embodiment of the invention, a separator is disposed between the air cathode and the anode and is infused with the non-aqueous, organic-solvent-based electrolyte including a lithium salt and an additive containing an alkylene group.

### BRIEF DESCRIPTION OF THE DRAWINGS

FIG. 1 is a schematic representation of a rechargeable battery cell according to an embodiment of the present invention.

FIG. 2 is a schematic representation of a rechargeable battery cell according to a second embodiment of the present invention.

FIG. 3 is a schematic representation of an embodiment of a cell assembly having a double-cell structure comprising a single anode flanked on both sides by a cathode according to the present invention.

FIG. 4 is a schematic representation of a step in the construction of a sealed cell according to an embodiment of the present invention.

FIG. 5 is a schematic representation of another step in the construction of a sealed cell according to an embodiment of the present invention.

FIG. 6 is a schematic representation of a further step in the construction of a sealed cell according to an embodiment of the present invention.

FIG. 7 is a box-plot graph comparing performance characteristics (Rest Voltage Before Cycling) of cells constructed in accordance with teachings of the present invention and cells not incorporating the teachings of the invention.

FIG. 8 is a box-plot graph comparing performance characteristics (Discharge Voltage During Second Cycle) of cells constructed in accordance with teachings of the present invention and cells not incorporating the teachings of the invention.

FIG. 9 is a box-plot graph comparing performance characteristics (Charge Voltage During Second Cycle) of cells constructed in accordance with teachings of the present invention and cells not incorporating the teachings of the invention.

### DETAILED DESCRIPTION

Embodiments of the present invention are described herein. The disclosed embodiments are merely exemplary of the invention that may be embodied in various and alternative forms, and combinations thereof. When the word “exemplary” is used herein, it is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, at least some specific structural and functional details disclosed herein are not to be interpreted as limiting, but merely as a basis for the claims and as a representative basis for teaching one skilled in the art to variously employ the present invention.

Overview

As an overview, the invention teaches an electrolyte for a rechargeable battery that has a lithium anode and an air cathode, which electrolyte helps to increase the useful life and effectiveness of the battery. The electrolyte taught by the invention also optimizes (lowers) the level of charge voltage required by the battery during recharging, thereby further increasing the usefulness of the battery.

A problem in providing an effective rechargeable lithium-air battery is that it is difficult to return the lithium anode to its pre-discharge condition because of imperfections formed on the surface of the anode during the discharge-recharge cycling. Imperfection problems include a roughening of the surface of the anode and the formation of pores in the anode. Another imperfection problem, and a very serious one, is that the surface of the lithium anode that is in contact with the electrolyte may be degraded by the formation of dendrites. Dendrites are thin protuberances that can grow upon and outwardly of a surface of an electrode during recharging of the cell. Recharging causes a re-plating of the lithium anode. Dendrites not only inhibit proper plating, or re-plating, of the electrode but, in addition, one or more branches of dendrites can grow long enough so as to extend through the electrolyte between the anode and cathode and thereby provide a direct connection that can electrically short circuit the cell. An electrical short is undesirable in and of itself but, in addition, the current passing through an electrical short may cause the temperature through the electrolyte to increase to a point wherein the electrolyte is no longer effective and/or the electrolyte and/or the cell itself may ignite.

In a cell, a film will typically form on a lithium electrode immersed in an electrolyte. Non-aqueous electrolytes are often used with lithium cells to avoid undesirable reactions between lithium and water-based electrolytes. A film forms on a lithium electrode because when lithium metal is immersed in non-aqueous liquid electrolyte, lithium metal will generally react with the electrolyte solvent, the electrolyte salt and trace impurities or dissolved gases to form the film. Rather than leaving the nature of the surface film that forms to chance, the invention modifies the film by introducing additives to the electrolyte solution which additives are tailored to react with the electrode surfaces and form a surface stabilizing film that is conducive to lithium cycling. The electrolyte of the invention changes the chemical composition of the film such that it adopts characteristics that inhibit the growth of dendrites on the lithium electrode. The invention thus converts the natural presence of the film to a beneficial use in fighting dendrite growth. To convert the film to a desirable composition, the invention uses as additives a class of organic compounds that are capable of being dissolved in the electrolyte solution and capable of polymerizing when placed in contact with lithium metal.

As a further aspect of this overview and introduction, it is to be noted that the air cathode that is utilized in the invention comprises a porous substrate that supports a material that serves as a catalyst to facilitate oxygen's role in the electrochemical reaction that produces energy. In a lithium-air battery, oxygen is the cathode reactant for the overall electrochemical reaction that creates electricity. Oxygen is placed in a condition for reacting at the substrate that forms the cathode support member. The cathode may employ a catalyst that facilitates oxygen's participation in the electrochemical reaction. The oxygen may be in an isolated (or pure state), or the cathode may use oxygen that is present in ambient air. The oxygen in ambient air is a natural component of air. Hence, the use of the term “air battery” or “lithium-air battery.”

Invention Described in Detail

Although the term “battery” technically may more properly define a combination of two or more cells, it has come to be used popularly to refer to a single cell. Thus the term battery by itself is sometimes for convenience of explanation used herein to refer to what is actually a single cell. The teachings herein that are applicable to a single cell are applicable equally to each cell of a battery containing multiple cells.

Referring now to the drawings, wherein like numerals indicate like elements throughout the several views, the drawings illustrate certain of the various aspects of exemplary embodiments.

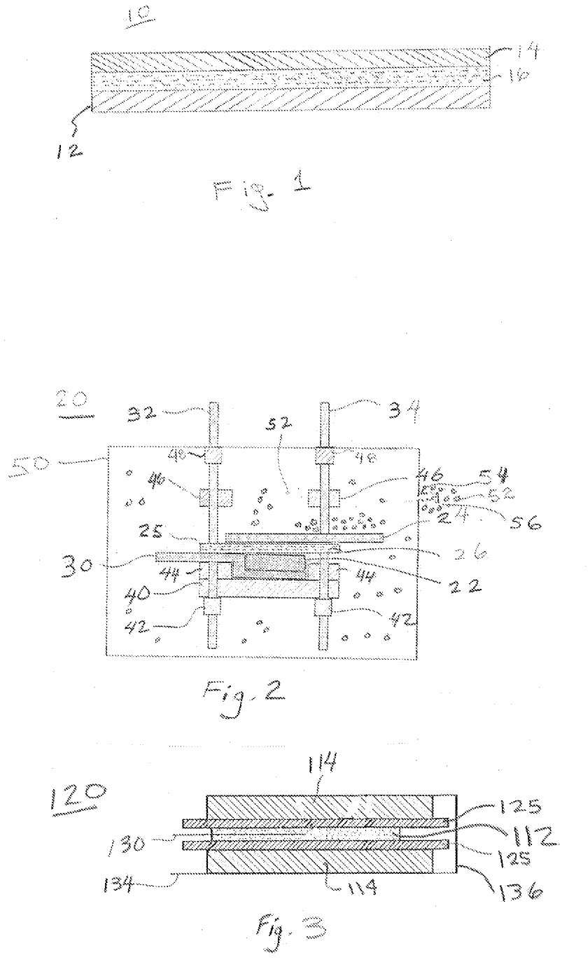

Referring first to FIG. 1, therein is illustrated a schematic representation of a rechargeable battery cell 10 according to an embodiment of the invention. A non-aqueous, organic-solvent-based electrolyte 16 is disposed between a spaced-apart pair of a lithium anode 12 and an air cathode 14. The electrolyte 16 includes a lithium salt and further includes an additive comprising an alkylene compound.

Referring now to FIG. 2, therein is illustrated a schematic representation of a rechargeable battery cell 20 according to a second embodiment of the present invention. In this embodiment, a separator 25 is disposed between and separates a lithium anode 22 and an air cathode 24. The separator 25 is infused with a non-aqueous, organic-solvent-based electrolyte 26. The electrolyte 26 includes a lithium salt and further includes an additive comprising an alkylene compound. The lithium anode 22 adjoins an anode current-collector 30. The anode current-collector 30 may be formed of copper metal or a copper alloy. An anode current-collector rod 32 is disposed in contact with the anode current-collector 30 and provides an anode connecting point for the cell 20. The anode current-connector rod 32 may be formed of a copper-based material such as copper metal or a copper alloy. A cathode current-connector rod 34 is disposed in contact with the air cathode 24 and provides a cathode connecting point for the cell 20. The cathode current-connector rod 34 may be formed of aluminum material such as aluminum metal or an aluminum alloy such as aluminum fused with zinc or copper. The above structures may be supported by a base 40 of rigid, non-reactive, non-electrically conductive material such as the polymer sold in block form under the brand name Teflon®. All of the various components described above in the second embodiment of the rechargeable cell 20 may be secured in a housing 50 forming a container. The components may be secured together and to the housing 50 by various securing mechanisms such as nuts 42, 44 that help secure the lower ends of the current-collector rods 32, 34 to the base 40 and nuts 48 that help secure the upper ends of the current-collector rods 32, 34 to the housing. Spacer elements help 46 press the electrode stack together while allowing oxygen to reach the cathode 24. The anode current-collector rod 32 extends through and helps secure the position of the separator 25 and the anode current-collector 30 while the cathode current-collector rod 34 extends through and helps secure the position of the separator 25 and air cathode 24. The anode 22 is secured at least in part by being sandwiched between the separator 25 and anode current-connector 30. The housing 50 may contain a quantity of oxygen or air 52 for reaction with the air cathode 24. The housing 50 may have an orifice 54 through which oxygen or ambient air 52 is introduced into the interior of the housing 50. A removable orifice cover 56 may be used to seal the orifice 54 until injection of oxygen or air is desired.

In either the first or second embodiment described above, the lithium anode 12, 22 is formed of lithium metal, a lithium-metal based alloy, a lithium-intercalation compound or lithium titanate (Li₄Ti₅O₁₂). As used herein, the term “lithium-intercalation compound” means those substances having a layered structure that is suitable for receiving and storing lithium compounds for later use (such as in a reaction). Thus these materials may also be considered “lithium-storage materials.” These lithium-intercalation, or lithium-intercalating, compounds are typically types of carbon. Lithium titanate is a lithium-containing compound. Lithium titanate functions similarly to a lithium-loaded intercalation compound when used as an anode material in a battery cell. The air cathode 14, 24 is predominantly a porous substrate. The air-cathode 14, 24 substrate may be infused with an oxygen-reduction catalyst to facilitate the oxygen reaction at the air cathode. A suitable oxygen-reduction catalyst comprises at least one of electrolytic manganese dioxide, ruthenium oxide, silver, platinum and iridium.

The separator 25 is made of a non-conductive polymer. The non-conductive polymer material may be porous, for example, in the nature of a sponge, so as to effectively hold the fluid electrolyte.

The invention modifies the lithium film that forms on a lithium electrode to produce a film that is conducive to lithium cycling (that is, discharging and recharging the cell 10/20). The film is modified by providing an electrolyte that has one or more additives that react with the electrode surfaces to form a surface-stabilizing film that is conducive to cycling.

An electrolyte for a battery cell typically comprises a salt dissolved in a solvent, often water. The invention employs a non-aqueous, organic-solvent-based electrolyte 16, 26 including a lithium salt and an alkylene additive. A non-aqueous electrolyte is used to avoid the damaging effects that water has upon lithium.

A suitable lithium salt for producing the electrolyte comprises at least one of lithium hexafluorophosphate, lithium tetrafluoroborate, lithium hexafluoroarsenate, lithium perchlorate, lithium bis(trifluorosulfonyl) imide, lithium bis(perfluoroethylsulfonyl) imide, lithium triflate, lithium bis(oxalato) borate, lithium tris(pentafluoroethyl) trifluorophosphate, lithium bromide, and lithium iodide. For convenience, the following table provides (molecular) chemical formulas for these salts:

Lithium Salts Suitable For Use In Producing An Electrolyte

| Molecular | Common Name or Alternative Name(s) or |
|---|---|
| Formula | Acronym(s) |
| LiPF₆ | lithium hexafluorophosphate |
| LiBF₄ | lithium tetrafluoroborate |
| LiAsF₆ | lithium hexafluoroarsenate |
| LiClO₄ | lithium perchlorate |
| LiB(C₂O₄)₂ | lithium bis(oxatlato)borate; [LiBOB] |
| LiN(SO₂CF₃)₂ | lithium bis(trifluorosulfonyl) imide; lithium |
| | trifluoromethanesulfonimide; lithium |
| | trifluoromethanesulphonylimide; lithium |
| | bis(trifluoromethane sulfone)imide; lithium |
| | bistrifluoromethanesulfonamide; [LiTFSI] |
| LiN(SO₂CF₂CF₃)₂ | lithium bis(perfluoroethylsulfonyl) imide |
| CF₃SO₃Li | lithium triflate; primary chemical name - |
| | lithium trifluoromethanesulfonate; also |
| | known as trifluoromethanesulfonic acid |
| | lithium salt |
| LiBr | lithium bromide |
| LiI | lithium iodide |
| Li(C₂F₅)₃PF₃ | lithium tris(pentafluoroethyl) |
| | trifluorophosphate |

To form the electrolyte solution, one or more of the above salts is dissolved in a solvent. Examples of suitable solvents are the following two solvent mixtures:
1:2 (w:w) propylene carbonate and tetraglyme (PC:Tetraglyme) (“Tetraglyme” is an amalgam of “tetraethylene glycol dimethyl ether”) and
1:2 (w:w) propylene carbonate and 1,2-dimethoxyethane (PC:DME).

Other suitable electrolyte solutions that may be employed in the invention are electrolyte solutions that are used for lithium-ion batteries. Such electrolyte solutions contain solvents that are based upon carbonates, esters, ethers, amines, amides, nitriles and sulfones. Such solvents include propylene carbonate, ethylene carbonate, dimethyl carbonate, diethyl carbonate, ethylene carbonate, 1,2-dimethoxyethane, diethyl carbonate, ethyl methyl carbonate, gamma-butyrolactone, sulfolane, 1,3-dioxolane, tetrahydrofuran, dimethoxyethane, diglyme, tetraglyme, diethyl ether, 2-methyl tetrahydrofuran, tetrahydropyran, pyridine, n-methylpyrrolidone, dimethyl sulfone, ethyl methyl sulfone, ethyl acetate, dimethyl formamide, dimethyl sulfoxide, acetonitrile, and methyl formate.

Suitable proportions of alkylene additives range from less than about 1% up to about 10% by weight. An embodiment of a cell constructed in accordance with the teachings of the invention is sealed in an enclosure wherein oxygen or air is injected to a predetermined pressure. Suitable operating pressure is in the range from about 0.1 atm to about 100 atm, and an optimum range is from about 0.5 atm to about 20 atm.

The additive for the non-aqueous, organic-solvent-based electrolyte 16, 26 comprises an alkylene compound. Suitable alkylene compounds are capable of dissolving in the electrolyte solution and also capable of polymerizing when coming into contact with lithium metal. Suitable alkylene compounds are alkylene carbonates, alkylene siloxanes, and combinations of alkylene carbonate and alkylene siloxane.

Suitable alkylene carbonates are vinylene carbonate, butylene carbonate, and a combination of vinylene carbonate and butylene carbonate. The following is a structural chemical formula for vinylene carbonate, which for convenience is sometimes herein abbreviated as “VC.”

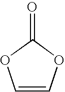

A suitable alkylene siloxane is a polymerizable silane. A suitable polymerizable silane is triacetoxyvinylsilane. The following is a structural chemical formula for the alkylene siloxane triacetoxyvinylsilane, which for convenience is sometimes herein abbreviated as “VS.”

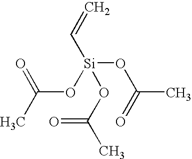

### Example of Production of Battery Cell

The following is an example of the production of a cell incorporating teachings of the invention. It should be understood, however, that the invention is not limited to the specific details set forth in the example. Parts and percentages set forth herein are by weight unless otherwise specified.

Anode and Air Cathode: General Construction and Materials—Suitable anode materials include but are not limited to lithium metal; lithium-metal-based alloys (for example, Li—Al, Li—Sn, and Li—Si); lithium-intercalating compounds that are typically used in Lithium-ion batteries such as but not limited to graphite, mesocarbon microbead (MCMB) carbon, soft carbon; and lithium titanate, which also frequently is used in lithium-ion batteries.

As practiced by the invention, a typical reversible air cathode initially contains about 14% lithium peroxide (Li₂O₂); however, the cell will operate effectively if the air cathode contains from about 0.5% to about 50% Li₂O₂. The addition of lithium peroxide to the air cathode helps facilitate the preservation of initial porosity of the air cathode. The lithium peroxide initially attaches to the porous structure of the substrate and then, when the cell is charged, the lithium peroxide participates in a chemical reaction that causes it to vacate the porous substrate thereby increasing the porosity of the substrate. The lithium peroxide thus helps preserve the intended initial porosity by more or less serving as a placeholder for open space in the air cathode.

Battery capacity increases with increasing proportion of active carbon and porosity. Suitable porous cathode active materials include but are not limited to Calgon™ carbon (activated carbon), carbon black (such as Timcal Super P Li carbon), metal powders (such as Ni powder), activated carbon cloths, porous carbon fiber papers, and metal foams. Calgon™ carbon refers to a product of Calgon Carbon Corporation.

Suitable binders for the carbon electrodes include but are not limited to carboxymethyl cellulose (CMC), polyimide (PI), polyvinylidene fluoride (PVDF) fluoropolymer resin, polytetrafluoroethylene (PTFE) fluoropolymer resin, Teflon® AF amorphous fluoropolymers (Teflon® is a registered trademark of E.I. du Pont de Nemours and Company), and fluorinated ethylene propylene (FEP).

Production of air cathode (Using Kynar® polyvinylidene fluoride (PVDF) fluoropolymer resin as binder)—Cathodes 14, 24 were prepared by milling 3 g KS10 graphite (carbon), 3 g Super P® Li (carbon black) (Super P® Li is a registered trademark of Timcal SA (Timcal AG) (Timcal Ltd) Corporation of Switzerland), 0.75 g vapor-grown carbon fiber (VGCF) 24 LD carbon fiber (such as the carbon nanofibers manufactured by Pyrograf Products, Inc., an affiliate of Applied Sciences, Inc.), 2.09 g Kynar® PVDF, 1.16 g EMD (electrolytic managanese dioxide, MnO₂), and 70 g ZrO₂ milling media with 130 mL acetone in a ZrO₂ jar at 300 rpm for 17.5 hours in a planetary mill. The milling media was removed by passing the resulting slurry through a wire screen. Cathodes were cast by spreading the slurry at a depth of 20 mil wet thickness onto a 19 cm×39 cm sheet of 0.2 oz/yd² (6.8 g/m²) non-woven carbon veil. The cathodes were allowed to dry under a cover with a ¼″ wide slot down the center, and cut into individual cathodes using a punch. The cathodes were then weighed and a group was selected having a narrow mass range to minimize variation due to the cathode during observation and testing.

Production of air cathode (Using as binder fluoropolymer resin as a negatively charged, hydrophobic colloid, containing approximately 60% (by total weight) of 0.05 to 0.5 μm polytetrafluoroethylene (PTFE) resin particles suspended in water, containing approximately 6% (by weight of PTFE) of a nonionic wetting agent and stabilizer)—To produce a Teflon®-bonded cell, a Calgon-carbon (activated carbon)-based air cathode 14, 24 is prepared by first wetting 14.22 g of Calgon™ carbon (activated carbon), 0.56 g of Acetylene Black (carbon black pigment), and 0.38 g of electrolytic manganese dioxide with a 60 ml mixture of isopropanol and water (1:2 ratio). Teflon® is a registered trademark of E.I. du Pont de Nemours and Company. Calgon™ carbon refers to a product of Calgon Carbon Corporation. The electrolytic manganese dioxide is an oxygen-reduction catalyst, optimally provided in a concentration of about 1% to about 30% by weight. Alternatives to the electrolytic manganese dioxide are ruthenium oxide, silver, platinum and iridium. Next, 2.92 g of Teflon® 30 (60% Teflon® emulsion in water) is added to the above mixture, mixed, and placed in a bottle with ceramic balls to mix overnight on a roller-run jar mill. Alternatively, the slurry may be planetary milled for 6 hours. After mixing, the slurry/paste is dried in an oven at 110 degrees C. for at least 6 hours to evaporate the water, and obtain a dry, fibrous mixture. The dry mixture is then once again wetted by a small quantity of water to form a thick paste, which is then spread over a clean glass plate (or polyester sheet). The mixture is kneaded to the desired thickness as it dries on the glass plate. After drying, it is cold pressed on an Adcote™-brand-adhesive-coated aluminum mesh at 4000 psi for 3 minutes. To remove any cracks in the paste, the cathode assembly is passed through stainless steel rollers. The cathode is then cut into smaller pieces such that the active area of the cathode is 2″ by 2″. A small portion of the aluminum mesh is exposed so that it may be used as the cathode current-collector tab.

Cell Assembly—The cell assembly is performed inside of an argon-filled glove box. This helps to eliminate undesirable effects upon the lithium electrode that are caused by water (particularly water vapor, or moisture, in air).

The cathode is wetted by a non-aqueous, organic-solvent based electrolyte including a lithium salt and an alkylene carbonate and/or an alkylene siloxane additive. The electrolyte may be lithium hexaflouraphosphate dissolved in a mixture of propylene carbonate and dimethyl ether to a 1 Molar concentration (1M LiPF₆ in PC:DME). A pressure-sensitive, porous polymeric separator membrane, such as Policell type B38 (product of Policell Technolgies, Inc.) is loaded with a non-aqueous, organic-solvent based electrolyte including a lithium salt and an alkylene additive. The alkylene additive may be an alkylene carbonate such as vinylene carbonate or butylene carbonate. Alternatively the additive may be an alkylene siloxane such as triacetoxyvinylsilane. The electrolyte-loaded separator membrane is placed on the cathode, with the shiny side of the membrane facing away from the cathode. Next, thin lithium foil is placed on the shiny side of the wetted separator, and a 1.5 cm by 4 cm strip of copper mesh is placed along one edge of the thin lithium foil (to serve as an anode current-collector tab), away from the aluminum-mesh cathode current-collector tab. Another cathode piece wetted by the electrolyte and covered with a second electrolyte-loaded separator is placed directly on top of the lithium foil and copper-mesh strip. This is an example of a double-cell assembly. It is illustrated schematically in FIG. 3. This is considered to be a “double cell” because there is a single substantially planar anode flanked on either side by a substantially planar cathode. FIG. 3 illustrates the arrangement of a pair of spaced-apart ones of the above-described air cathodes 114 each having one of the above-described separators 125 separating the cathodes 114 from the centrally-disposed, thin lithium foil anode 112. An anode current-collector tab 130 extends from the anode 112. A cathode current-collector tab 134 extends from one of the cathodes 114 and a cathode current-collector connector 136 connects the current collector portions of the cathodes 114.

The double-cell assembly is laminated on a hot press at 100 degrees C. and 500 lb pressure for 30 to 40 seconds. After the sample is withdrawn from the press, the heat-activated separator binds the sample together.

Production of Completed, Enclosed Cell—Production of Samples and Testing—Completed, enclosed cells were produced and tested. Completed, enclosed cells comprise a cell assembly placed in an enclosure with an electrolyte and then activated for use. The cell assembly comprises the cathode-anode-separator assembly such as the double-cell assembly described above. Although the example described above is based upon a double cell, the teachings of the invention are equally applicable to a single-cell configuration or a multiple-cell configuration other than the single anode-dual cathode configuration described. The completed cells were also assembled in a glove box to isolate the components.

Various samples of completed cells were prepared for testing in which the liquid electrolyte employed contained either one of two general types of additives or no additive. The two general additives were (a) 2% by weight VS (triacetoxyvinylsilane, a polymerizable silane which is a suitable alkylene siloxane additive taught by the invention and described herein) or (b) 5% by weight VC (vinylene carbonate, an alkylene carbonate additive as taught and described herein).

The Electrolyte—A salt for forming an electrolyte for both the cathode and the separator may comprise one or more of the salts from the above table entitled “Lithium Salts Suitable For Use In Producing An Electrolyte.” The liquid electrolyte used for testing was a 1 M solution of lithium trifluoromethanesulfonimide (LiTFSI) or a 1 M solution of lithium hexafluorophosphate (LiPF₆). The salts were employed in solvent mixtures comprised of a 1:2 (w:w) ratio of propylene carbonate and tetraglyme (PC:Tetraglyme) or a 1:2 (w:w) ratio of propylene carbonate and 1,2-dimethoxyethane (PC:DME). Other suitable electrolytic solutions are those used for lithium-ion batteries which solutions consist of solvents based on carbonates, esters, ethers, amines, amides, nitriles and sulfones. These solvents include propylene carbonate, ethylene carbonate, di-methyl carbonate, diethyl carbonate, ethylene carbonate, 1,2-dimethoxyethane, diethyl carbonate, ethyl methyl carbonate, gamma-butyrolactone, sulfolane, 1,3-dioxolane, tetrahydrofuran, dimethoxyethane, diglyme, tetraglyme, diethyl ether, 2-methyl tetrahydrofuran, tetrahydropyran, pyridine, n-methylpyrrolidone, dimethyl sulfone, ethyl methyl sulfone, ethyl acetate, dimethyl formamide, dimethyl sulfoxide, acetonitrile, and methyl formate.

As taught by the invention, an alkylene additive (that is, an additive containing an alkylene group) such as alkylene carbonate or/and alkylene siloxane improves the performance the electrolyte in facilitating multiple cycling of the cell. Alkylene carbonate additives include vinylene carbonate and butylene carbonate. An example of a suitable alkylene siloxane additive is triacetoxyvinylsilane. Suitable alkylene additives range from less than about 1% up to about 10% by weight. An embodiment of a cell constructed in accordance with the teachings of the invention is sealed in an enclosure wherein oxygen or air is injected to a predetermined pressure. Suitable operating pressure is in the range from about 0.1 atm to about 100 atm, and an optimum range is from about 0.5 atm to about 20 atm.

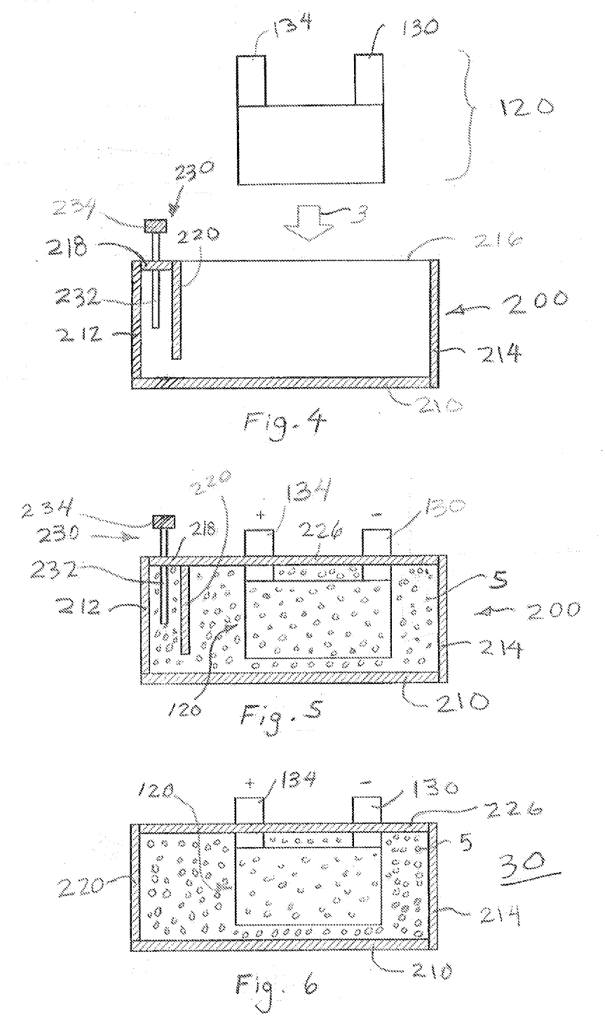

Reference is now made generally to FIGS. 4, 5 and 6, which are schematic representations of a cell assembly 120 placed within a bag container 200 to form a completed, sealed cell 300 in accordance with the present invention. First, reference is made specifically to FIG. 4, in which a bag 200 made of multilayer polymer and metal laminate is pre-sealed completely on three sides and has a fourth side that is partially pre-sealed. A suitable polymer is polypropylene such as the thin-sheet polypropylene product manufactured and sold by E.I. du Pont de Nemours and Company under the trademark DuPont™ Surlyn®. In FIG. 4, sealing is indicated by spaced-apart double lines with cross-hatching which double lines extend across the lower-most edge 210 and parallel side edges 212, 214. The fourth side, which is an upper-most edge in the orientation of FIG. 4, has an opening 216 along a portion of its length adjacent a sealed portion 218 of the upper-most edge. The partially-sealed bag essentially forms a pouch that is open at the top. An inner seal 220 extends parallel to one sealed side edge 212 for a substantial distance. The inner seal 220, parallel side edge 212 and partial seal 218 of the upper-most edge form a substantially U-shaped cavity. The upper-edge partial seal 218 seals a shaft 232 of a hypodermic needle 230 in the U-shaped cavity. The hypodermic needle 230 has an uppermost end 234 that is adapted for receiving an instrument for injection of a gas. The uppermost end 234 is particularly adapted for receiving a syringe (not shown) through which oxygen or air (that contains oxygen) is infused into the bag 200. Prior to placement of the needle 230 in the bag 200, the upper end 234 of the needle 230 may be sealed with epoxy or by other known means to prevent moisture from being introduced into the bag (because of the undesirable interaction of water with lithium). After ensuring that the cathode is not peeling from the separator, the cell assembly 120 is soaked in the electrolyte for at least 5 to 10 minutes, and then inserted (as shown by the direction arrow 3) into the preassembled pouch/partially sealed bag 200 with the anode current-collector tab 130 and the cathode current-collector tab 134 extending outwardly of the upper edge of the bag 200.

Referring now to FIG. 5, after the cell assembly 120 has been inserted, the bag container 200 is sealed across the current-collector mesh tabs thus forming the completed upper-most seal 226. The fully-sealed bag 200 is then removed from the glove box and oxygen or air is injected into the bag. For example, a syringe (not shown) may be connected to the upper end 234 of the needle 230 so as to penetrate the sealed (epoxy or otherwise) opening and inject oxygen or air 5 into the bag 220.

Referring now to FIG. 6, after oxygen 5 has been injected into the bag 200, the partial inner seal 220 is fully extended between the upper-most sealed edge 226 and lower-most sealed edge 210 of the bag 200, thus segregating the needle shaft 232. Sealing may be accomplished through use of a heat-sealing device commonly known as an impulse sealer. The needle-containing portion of the bag then may be removed by simple cutting, trimming or other conventional means leaving a completed, sealed cell 300 in accordance with the teachings of the invention.

### Testing of Embodiments

Embodiments of cells incorporating the teachings of the invention and cells not incorporating the teachings of the invention were tested to compare the performances of each one to another. The following three performance characteristics were tested:

Rest Voltage Before Cycling

Discharge Voltage During Second Cycle

Charge Voltage During Second Cycle

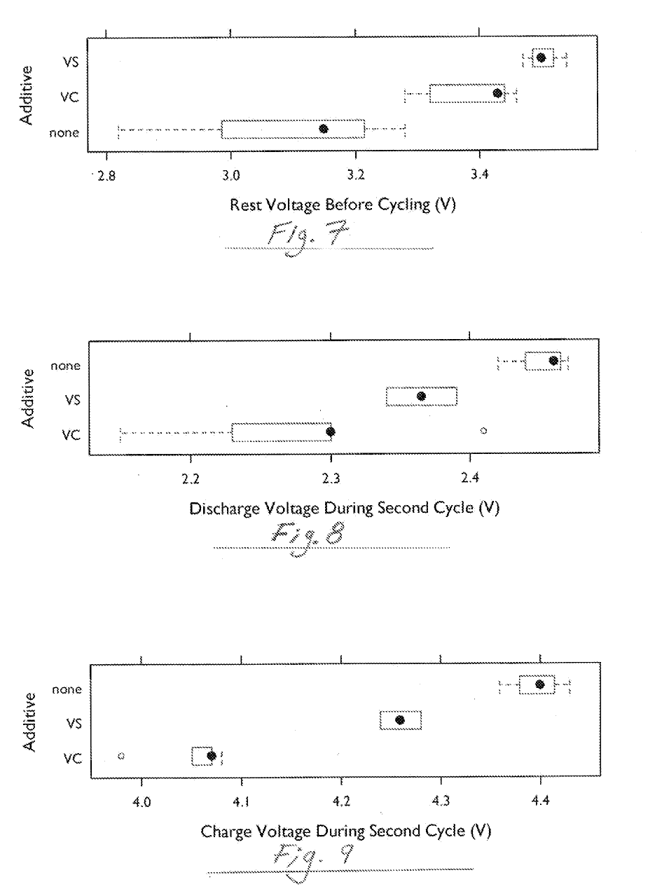

FIGS. 7-9 are box-plot graphs of data recorded for the three characteristics described above. A “cycle” that is referred to in the testing described herein refers to the period in which a fully-charged cell is discharged to a predetermined level and then re-charged to maximum capacity. Charge to more than 4.6V will enhance the desired decomposition of Li₂O₂. Suitable voltage ranges for charging and discharging are: 4 to 4.8V for charging and 3 to 1.5V for discharging. Increasing charging voltage significantly increases the reversibility of the battery.

The results of testing were compared and analyzed utilizing the statistics methodology known as Analysis of Variance (ANOVA). Measurements taken during the second cycle exhibited differences that were considered to be statistically significant and have been described herein.

Referring to FIG. 7, therein is shown a box-plot graph of rest voltage, in volts (V), before cycling for cells tested. The rest voltage (V) for each cell was recorded at the end of the initial rest (or “pre-charging” period, prior to the first discharge). Cells containing the VS additive and the VC additive showed increases in rest voltage over the non-additive cells which increases are statistically significant by ANOVA. Although the rest voltage for the VS sample appears higher than for VC in the box plot of FIG. 7, review using ANOVA principals indicates that they are statistically indistinguishable.

Referring now to FIG. 8, therein is shown a box-plot graph of discharge voltage (V) during the second cycle. This is a representation of the average voltage discharged or dissipated in the second cycle. Battery cells that did not contain an additive according to the present invention gave a statistically higher voltage than cells containing the VC additive according to the invention; however, discharge voltage for cell embodiments containing the VS additive according to the invention were indistinguishable from discharge voltage for cells containing no invention additive and the discharge voltage for cell embodiments containing the VC additive according to the invention was indistinguishable from the discharge voltage for cells containing the VS additive according to the invention.

Referring now to FIG. 9, therein is shown a box-plot graph comparing charge voltage (V) during a second cycle, that is, the voltage (V) that was required to fully charge the cells. The charge voltage for the second cycle was lowest for cell embodiments containing VC additive, second lowest for cell embodiments containing VS additive and highest for cells containing neither of the additives taught by the invention.

When the VS additive is utilized in combination with a nonvolatile, liquid electrolyte such as 1 M LiTFSI in 2:1 propylene carbonate (PC):tetraglyme, the VS additive serves to increase the round-trip efficiency by reducing the charge voltage. Round-trip efficiency is a tool that may be used to compare the effectiveness of one rechargeable cell to another. Round-trip efficiency may be described as a ratio of the total discharge energy E_{dis} (watt-hours) that is dissipated by a cell during a cycle as compared to the total energy E_{ch} (watt hours) required to be applied to fully re-charge a cell after discharge during a cycle. The relationship may be described mathematically as follows:

$$Round \text{-} Trip Efficiency , {e}_{rt , n} = \frac{( 100 ) {E}_{dis , n}}{{E}_{ch , n - 1}} \%$$

wherein
n=cycle number
E_{dis}=Total energy discharged during the cycle “n.”
E_{ch}=Total energy that is applied to re-charge a battery cell at the end of the preceding cycle, that is “n−1.”
   As noted above, Round-Trip Efficiency is expressed as a percentage (%).

The invention provides a cell that requires a lesser amount of charge energy E_{ch}, thus decreasing the denominator of the above equation, thereby increasing the round-trip efficiency.

The term “air” as used herein is not intended to be limited to ambient air but includes other combinations of gases containing oxygen, and, further, is meant to refer to pure oxygen. As previously noted herein, oxygen is a reactant in the electrochemical process of the invention and references to the term “air” are meant to imply that it is the oxygen in air that is applicable. Thus this broad definition of “air” applies to all uses of that term herein, including but not limited to lithium-air, air battery, air cathode, and air supply.

It is to be understood that the described invention may include a battery that has not yet formed the active material of the anode or a battery which includes a preformed anode containing active material. When the battery does not yet include active anode material, the active anode material is formed upon initial charging of the battery.

The invention provides a lithium-air battery (battery cell) having an electrolyte that is non-volatile, stable in contact with metallic lithium, stable against cathode oxidation during lithium-air charging and able to improve the round-trip charge/discharge efficiency.

Many variations and modifications may be made to the above-described embodiments without departing from the scope of the claims. All such modifications, combinations, and variations are included herein by the scope of this disclosure and the following claims.

1. A rechargeable battery comprising:
an anode and an air cathode spaced apart from one another; and
a non-aqueous, organic-solvent-based electrolyte including a lithium salt and an additive containing an alkylene group, disposed between said air cathode and said anode.

2. The rechargeable battery of claim 1, wherein said lithium salt is selected from the group consisting of lithium hexafluorophosphate, lithium tetrafluoroborate, lithium hexafluoroarsenate, lithium perchlorate, lithium bis(trifluorosulfonyl)imide, lithium bis(perfluoroethylsulfonyl)imide, lithium triflate, lithium bis(oxalato) borate, lithium tris(pentafluoroethyl)trifluorophosphate, lithium bromide, and lithium iodide.

3. The rechargeable battery of claim 1, wherein said additive containing an alkylene group is selected from the group consisting of alkylene carbonate, alkylene siloxane, and a combination of alkylene carbonate and alkylene siloxane.

4. The rechargeable battery of claim 3, wherein said alkylene carbonate is selected from the group consisting of vinylene carbonate, butylene carbonate, and a combination of vinylene carbonate and butylene carbonate.

5. The rechargeable battery of claim 3, wherein said alkylene siloxane is a polymerizable silane.

6. The rechargeable battery of claim 5, wherein said polymerizable silane is triacetoxyvinylsilane.

7. The rechargeable battery of claim 1, wherein said anode comprises at least one of lithium metal, a lithium-metal based alloy, a lithium-intercalation compound and lithium titanate.

8. The rechargeable battery of claim 7, wherein said lithium-intercalation compound comprises at least one of graphite, mesocarbon microbead (MCMB) carbon, and soft carbon.

9. The rechargeable battery of claim 1, wherein said air cathode is carbon-based.

10. The rechargeable battery of claim 1, wherein said air cathode is porous.

11. The rechargeable battery of claim 1, wherein said air cathode comprises a carbon-based, porous electrode including a non-aqueous, organic-solvent-based electrolyte including a lithium salt and an additive containing an alkylene group.

12. The rechargeable battery of claim 11, wherein said lithium salt is selected from the group consisting of lithium hexafluorophosphate, lithium tetrafluoroborate, lithium hexafluoroarsenate, lithium perchlorate, lithium bis(trifluorosulfonyl)imide, lithium bis(perfluoroethylsulfonyl)imide, lithium triflate, lithium bis(oxalato) borate, lithium tris(pentafluoroethyl)trifluorophosphate, lithium bromide, and lithium iodide.

13. The rechargeable battery of claim 11, wherein said additive containing an alkylene group is selected from the group consisting of alkylene carbonate, alkylene siloxane, and a combination of alkylene carbonate and alkylene siloxane.

14. The rechargeable battery of claim 13, wherein said alkylene carbonate is selected from the group consisting of vinylene carbonate, butylene carbonate, and a combination of vinylene carbonate and butylene carbonate.

15. The rechargeable battery of claim 13, wherein said alkylene siloxane is a polymerizable silane.

16. The rechargeable battery of claim 15, wherein said polymerizable silane is triacetoxyvinylsilane.

17. The rechargeable battery of claim 1, wherein said air cathode is loaded with an oxygen-reduction catalyst.

18. The rechargeable battery of claim 17, wherein said oxygen-reduction catalyst is selected from the group consisting of electrolytic manganese (IV) dioxide, ruthenium (IV) oxide, copper (II) oxide, copper (II) hydroxide, iron (II) oxide, iron (II,III) oxide, cobalt (II,III) oxide, nickel (II) oxide, silver, platinum and iridium.

19. The rechargeable battery of claim 17, wherein the concentration of oxygen-reduction catalyst is between about 1% and about 30% by weight.

20. The rechargeable battery of claim 1, further comprising a separator disposed between said anode and said air cathode infused with said non-aqueous, organic-solvent-based electrolyte including a lithium salt and an additive containing an alkylene group.

21. The rechargeable battery of claim 20, wherein said separator comprises a polymeric material.

22. The rechargeable battery of claim 20, wherein said separator is porous.

23. The rechargeable battery of claim 1, further comprising a housing enclosing said anode, said air cathode, said non-aqueous, organic-solvent-based electrolyte including a lithium salt and an additive containing an alkylene group, and a quantity of oxygen.

24. The rechargeable battery of claim 23, wherein said oxygen is a component of air.

25. The rechargeable battery of claim 23, wherein said housing includes an orifice through which a gas may be introduced into an interior of said housing, said aperture selectively closeable between a substantially open condition and a substantially closed condition wherein said housing is sealed.

26. A cathode for an air battery, the cathode comprising a carbon-based, porous electrode including a lithium salt and an additive containing an alkylene group.

27. The rechargeable battery of claim 26, wherein said lithium salt is selected from the group consisting of lithium hexafluorophosphate, lithium tetrafluoroborate, lithium hexafluoroarsenate, lithium perchlorate, lithium bis(trifluorosulfonyl)imide, lithium bis(perfluoroethylsulfonyl)imide, lithium triflate, lithium bis(oxalato) borate, lithium tris(pentafluoroethyl)trifluorophosphate, lithium bromide, and lithium iodide.

28. The rechargeable battery of claim 26, wherein said additive containing an alkylene group is selected from the group consisting of alkylene carbonate, alkylene siloxane, and a combination of alkylene carbonate and alkylene siloxane.

29. The rechargeable battery of claim 28, wherein said alkylene carbonate is selected from the group consisting of vinylene carbonate, butylene carbonate, and a combination of vinylene carbonate and butylene carbonate.

30. The rechargeable battery of claim 28, wherein said alkylene siloxane is a polymerizable silane.

31. The rechargeable battery of claim 30, wherein said polymerizable silane is triacetoxyvinylsilane.
